(19) United States
(12) Patent Application Publication
(10) Pub. No.: US 2013/0168389 A1
(43) Pub. Date: Jul. 4, 2013

(54) MICROWAVE HEATING APPARATUS AND PROCESSING METHOD

(71) Applicant: TOKYO ELECTRON LIMITED, Tokyo (JP)

(72) Inventors: Taro IKEDA, Yamanashi (JP); Sumi TANAKA, Yamanashi (JP)

(73) Assignee: TOKYO ELECTRON LIMITED, Tokyo (JP)

(21) Appl. No.: 13/726,963

(22) Filed: Dec. 26, 2012

(30) Foreign Application Priority Data
Dec. 28, 2011 (JP) 2011-289025

(51) Int. Cl. H05B 6/64

(52) U.S. Cl. CPC H05B 6/6402
USPC 219/756

(57) ABSTRACT

Four microwave introduction ports are arranged to deviate from directly above a wafer in such a way that the long sides thereof are in parallel to at least one of the four straight sides. The top surface of a rectifying plate which surrounds the wafer is inclined so as to be widened from the side of the wafer (inner side) toward the side of a sidewall portion (outer side) to form an inclined portion. The inclined portion is disposed to face the four microwave introduction ports in a vertical direction.

### CROSS-REFERENCE TO RELATED APPLICATIONS

This application claims priority to Japanese Patent Application No. 2011-289025 filed on Dec. 28, 2011, the entire contents of which are incorporated herein by reference.

### FIELD OF THE INVENTION

The present invention relates to a microwave heating apparatus for performing a predetermined process by introducing a microwave into a processing chamber and a processing method for heating a target object to be processed by using the microwave heating apparatus.

### BACKGROUND OF THE INVENTION

As an LSI device or a memory device is miniaturized, a depth of a diffusion layer in a transistor manufacturing process is decreased. Conventionally, doping atoms implanted into the diffusion layer are activated by a high-speed heating process referred to as an RTA (Rapid Thermal Annealing) using a lamp heater. However, in the RTA process, as the diffusion of the doping atoms progresses, the depth of the diffusion layer exceeds a tolerable range, and this makes the miniaturized design difficult. Since the depth of the diffusion layer is incompletely controlled, the electrical characteristics of devices are deteriorated due to occurrence of leakage current or the like.

Recently, an apparatus using microwaves has been suggested as an apparatus for heating a semiconductor wafer. When doping atoms are activated by microwave heating, a microwave directly acts on the doping atoms. Hence, excessive heating does not occur, and the diffusion of the diffusion layer can be suppressed.

As for the heating apparatus using microwaves, a substrate processing apparatus is suggested in, e.g., Japanese Patent Application Publication No. 2011-66254. The substrate processing apparatus is configured in such a way that a line connecting a surface of the inner wall of a processing chamber facing a processing surface of a substrate supported by a substrate supporting unit and a surface formed by an opening/closing portion serving as a part of the inner wall of the processing chamber in the case of closing a substrate loading/unloading port is inclined with respect to the processing surface of the substrate.

When doping atoms are activated by microwave heating, it is required to supply a power larger than a certain level. Accordingly, microwaves may efficiently be introduced into a processing chamber by providing a plurality of microwave introduction ports. When a plurality of microwave introduction ports is provided, microwaves introduced from one of the microwave introduction ports may enter another microwave introduction port, thereby deteriorating power use efficiency and heating efficiency.

In the case of microwave heating, when microwaves are directly irradiated to a semiconductor wafer disposed immediately below the microwave introduction ports, the surface of the semiconductor wafer is not uniformly heated.

### SUMMARY OF THE INVENTION

In view of the above, the present invention provides a microwave heating apparatus and a processing method which are capable of uniformly processing a target object with high power use efficiency and heating efficiency.

In accordance with an aspect of the present invention, there is provided a microwave heating apparatus including a processing chamber configured to accommodate a target object to be processed, the processing chamber having therein a microwave irradiation space; a supporting unit configured to support the target object in the processing chamber; and a microwave introducing unit configured to introduce microwaves for heating the target object into the processing chamber.

The processing chamber includes a top wall, a bottom wall and a sidewall which has four straight sides in a horizontal cross section. The microwave introducing unit has a first to a fourth microwave source. The top wall has a first to a fourth microwave introduction port through which the microwaves generated by the first to the fourth microwave source are introduced into the processing chamber.

Each of the first to the fourth microwave introduction port is of a substantially rectangular shape having long sides and short sides in a plan view, and microwave introduction ports may be disposed in such a way that the long sides thereof are in parallel to at least one of the four straight sides. Further, the first to the fourth microwave introduction port is disposed outwardly of the target object in such a way as not to be overlapped in a vertical direction with the target object supported by the supporting unit, and an inclined portion serving to reflect the microwaves toward the target object is provided directly below the microwave introduction ports.

The first to the fourth microwave introduction ports may be circumferentially disposed at positions spaced from each other at angle of about 90°, and each of the straight sides may be provided to correspond to one of the first to the fourth microwave introduction ports.

The sidewall may have the four straight sides and curved sides disposed between the adjacent straight sides in a horizontal cross section.

The inclined portion may be provided to surround the target object.

The microwave radiation space may be defined by the top wall, the sidewall and a partition provided between the top wall and the bottom wall, and the inclined portion may be provided at the partition.

The inclined portion may include an inclined surface having an upper end higher than a reference position corresponding to a height of the target object and a lower end lower than the reference position.

In accordance with another aspect of the present invention, there is provided a processing method for heating a target object to be processed by using a microwave heating apparatus including: a processing chamber configured to accommodate the target object, the processing chamber having therein a microwave irradiation space; a supporting unit configured to support the target object in the processing chamber; and a microwave introducing unit configured to introduce microwaves for heating the target object into the processing chamber.

The processing chamber includes a top wall, a bottom wall and a sidewall which has four straight sides in a horizontal cross section. The microwave introducing unit has a first to a fourth microwave source. The top wall has a first to a fourth microwave introduction port through which the microwaves generated by the first to the fourth microwave source are introduced into the processing chamber.

Each of the first to the fourth microwave introduction port is of a substantially rectangular shape having long sides and short sides in a plan view, and microwave introduction ports may be disposed in such a way that the long sides thereof are in parallel to at least one of the four straight sides. Further, the first to the fourth microwave introduction port is disposed outwardly of the target object in such a way as not to be overlapped in a vertical direction with the target object supported by the supporting unit, and an inclined portion serving to reflect the microwaves toward the target object is provided directly below the microwave introduction ports.

In the microwave heating apparatus and the processing method in accordance with the aspects of the present invention, the loss of the microwaves radiated into the processing chamber is reduced, so that the power use efficiency and the heating efficiency can be improved. Further, the target object can be uniformly heated.

### BRIEF DESCRIPTION OF THE DRAWINGS

The objects and features of the present invention will become apparent from the following description of embodiments, given in conjunction with the accompanying drawings, in which:

FIG. 1 is a cross sectional view showing a schematic configuration of a microwave heating apparatus in accordance with an embodiment of the present invention;

FIG. 2 explains a schematic configuration of a high voltage power supply unit of a microwave introducing unit in the embodiment of the present invention;

FIG. 3 is a plan view showing a bottom surface of a ceiling portion of a processing chamber shown in FIG. 1;

FIG. 4 is an enlarged view of a microwave introduction port;

FIG. 5 explains a function of an inclined portion;

FIG. 6 explains a structure of a control unit shown in FIG. 1;

FIGS. 7A and 7B schematically show electromagnetic vectors of microwaves radiated from a microwave introduction port;

FIG. 8A shows a simulation result of a power absorption ratio in a comparative example; and

FIG. 8B shows a simulation result of a power absorption ratio in the embodiment of the present invention.

### DETAILED DESCRIPTION OF THE EMBODIMENTS

Hereinafter, a microwave heating apparatus in accordance with an embodiment of the present invention will be described with reference to the accompanying drawings.

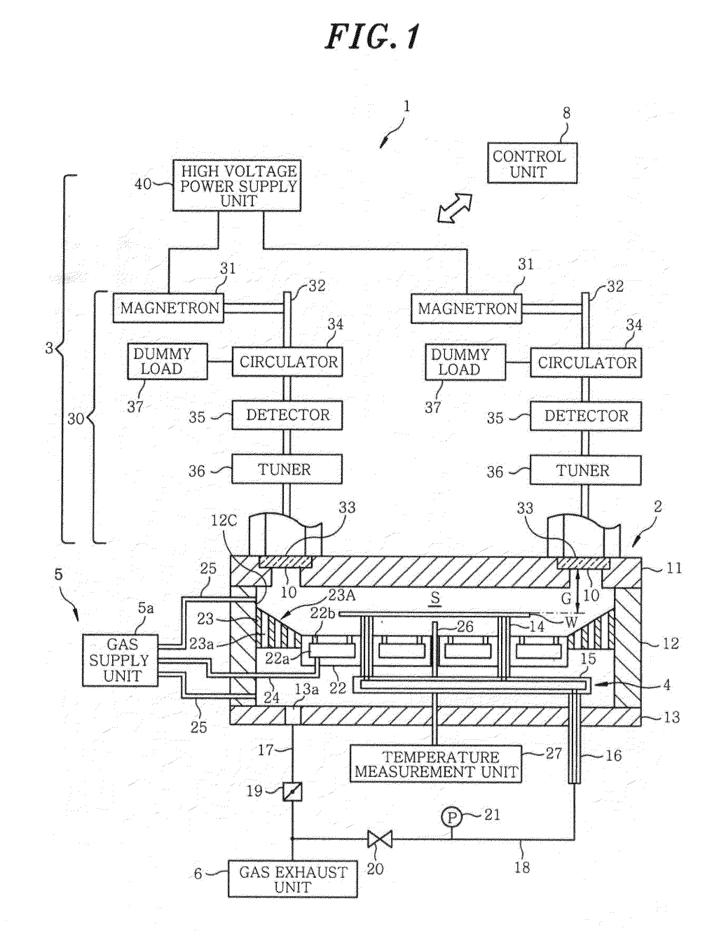

First, a schematic configuration of the microwave heating apparatus will be described with reference to FIG. 1. FIG. 1 is a cross sectional view showing the schematic configuration of the microwave heating apparatus. The microwave heating apparatus 1 of the present embodiment performs an annealing process by irradiating microwaves to, e.g., a semiconductor wafer (hereinafter, simply referred to as “wafer”) for manufacturing semiconductor devices through a series of consecutive operations.

The microwave heating apparatus 1 includes: a processing chamber 2 accommodating a wafer W as a target object to be processed; a microwave introducing unit 3 for introducing microwaves into the processing chamber 2; a supporting unit 4 for supporting a wafer W in the processing chamber 2; a gas supply mechanism 5 for supplying a gas into the processing chamber 2; a gas exhaust unit 6 for vacuum-exhausting the processing chamber 2; and a control unit 8 for controlling the respective components of the microwave heating apparatus 1.

<Processing Chamber>

The processing chamber 2 is made of a metal material, such as aluminum, aluminum alloy, stainless steel or the like, for example.

The processing chamber 2 has a hollow inside and includes a plate-shaped ceiling portion 11 serving as a top wall; a bottom portion 13 serving as a bottom wall; a sidewall portion 12 serving as sidewalls for connecting the ceiling portion 11 and the bottom portion 13; a plurality of microwave introduction ports 10 vertically extending through the ceiling portion 11; a loading/unloading port (not shown) provided at the sidewall portion 12; and a gas exhaust port 13a provided at the bottom portion 13.

Through the loading/unloading port, the wafer W is loaded and unloaded with respect to a transfer chamber (not shown) adjacent to the processing chamber 2. A gate valve (not shown) is provided between the processing chamber 2 and the transfer chamber. The gate valve serves to open and close the loading/unloading port. When the gate valve is closed, the processing chamber 2 is airtightly sealed. When the gate valve is opened, the wafer W is can be transferred between the processing chamber 2 and the transfer chamber. The shape of the sidewall portion 12 will be described in detail later.

The microwave introducing unit 3 is provided above the processing chamber 2 to introduce electromagnetic wave (microwave) into the processing chamber 2. The configuration of the microwave introducing unit 3 will be described in detail later.

<Supporting Unit>

The supporting unit 4 includes a plate-shaped hollow lift plate 15 provided in the processing chamber 2; a plurality of tube-shaped supporting pins 14 extending upward from a top surface of the lift plate 15; and a tube-shaped shaft 16 extending from a bottom surface of the lift plate 15 to the outside of the processing chamber 2 through the bottom portion 13. The shaft 16 is fixed to an actuator (not shown) outside of the processing chamber 2.

The supporting pins 14 serve to contact with the wafer W and support the wafer W in the processing chamber 2. The upper portions of the supporting pins 14 are arranged along the circumferential direction of the wafer W. Further, the supporting pins 14, the lift plate 15 and the shaft 16 are configured such that the wafer W can be vertically displaced by the actuator.

Moreover, the supporting pins 14, the lift plate 15 and the shaft 16 are configured such that the wafer W can be attracted onto the supporting pins 14 by the gas exhaust unit 6. Specifically, each of the supporting pins 14 and the shaft 16 has a tube shape communicating with the inner space of the lift plate 15. Further, suction holes for sucking the bottom surface of the wafer W are formed at the upper portions of the supporting pins 14.

The supporting pins 14 and the lift plate 15 are made of a dielectric material, e.g., quartz, ceramic or the like.

<Gas Exhaust Unit>

The microwave heating apparatus 1 further includes a gas exhaust line 17 for connecting a gas exhaust port 13a and the gas exhaust unit 6; a gas exhaust line 18 for connecting the shaft 16 and the gas exhaust line 17; a pressure control valve 19 disposed on the gas exhaust line 17; and an opening/closing valve 20 and a pressure gauge 21 which are disposed on the gas exhaust line 18. The gas exhaust line 18 is directly or indirectly connected to the shaft 16 so as to communicate with the inner space of the shaft 16. The pressure control vale 19 is provided between the gas exhaust port 13a and the connection node of the gas exhaust lines 17 and 18.

The gas exhaust unit 6 has a vacuum pump such as a dry pump or the like. By operating the vacuum pump of the gas exhaust unit 6, the inner space of the processing chamber 2 is vacuum-exhausted. At this time, by opening the opening/closing valve 20, the bottom surface of the wafer W is sucked, so that the wafer W is attracted and fixed to the supporting pins 14. Further, a gas exhaust equipment provided at a facility where the microwave heating apparatus 1 is installed may be used instead of the vacuum pump of the gas exhaust unit 6.

<Gas Introducing Mechanism>

As described above, the microwave heating apparatus 1 includes the gas supply mechanism 5 for supplying a gas into the processing chamber 2. The gas supply mechanism 5 includes a gas supply unit 5a provided with a gas supply source (not shown); a shower head 22 provided below a position where the wafer W is to be disposed in the processing chamber 2; a substantially ring-shaped rectifying plate 23 arranged between the shower head 22 and the sidewall portion 12; a line 24 for connecting the shower head 22 and the gas supply unit 5a; and a plurality of lines 25, connected to the gas supply unit 5a, for introducing a processing gas into the processing chamber 2. The shower head 22 and the rectifying plate 23 are made of a metal material, e.g., aluminum, aluminum alloy, stainless steel or the like.

The shower head 22 serves to cool the wafer W by using a cooling gas in the case of performing a relatively low temperature process on the wafer W. The shower head 22 includes a gas channel 22a communicating with the line 24; and a plurality of gas injection holes 22b communicating with the gas channel 22a to inject a cooling gas toward the wafer W. In the example shown in FIG. 1, the gas injection holes 22b are formed at the top surface of the shower head 22. The shower head 22 is not a necessary component of the microwave heating apparatus 1 and thus may not be provided.

The rectifying plate 23 has a plurality of rectifying openings 23a vertically extending through the rectifying plate 23. The rectifying plate 23 serves to allow a gas to flow toward the gas exhaust port 13a while rectifying an atmosphere at a location where the wafer W is to be disposed in the processing chamber 2. An inclined portion 23A is provided at a top surface (facing the ceiling portion 11) of the rectifying plate 23. A detailed structure of the inclined portion 23A will be described later.

The gas supply unit 5a is configured to supply a processing gas or a cooling gas, e.g., N₂, Ar, He, Ne, O₂, H₂ or the like. Further, as for a unit for supplying a gas into the processing chamber 2, an external gas supply unit that is not included in the microwave heating apparatus 1 may be used instead of the gas supply unit 5a.

The microwave heating apparatus 1 includes mass flow controllers (not shown) and opening/closing valves (not shown) disposed on the lines 24 and 25. Types of gases to be supplied into the shower head 22 and the processing chamber 2, and the flow rates thereof are controlled by the mass flow controllers and the opening/closing valves.

<Microwave Radiation Space>

In the microwave heating apparatus 1 of the present embodiment, a microwave radiation space “S” is formed of a space defined by the ceiling portion 11, the four sidewall portion 12, the shower head 22 and the rectifying plate 23 in the processing chamber 2. Microwaves are radiated into the microwave radiation space S through a plurality of microwave introduction ports 10 provided at the ceiling portion 11. Here, the shower head 22 and the rectifying plate 23 also serve as partitioning portions for defining the lower side of the microwave radiation space S in the processing chamber 2. Since each of the ceiling portion 11, the sidewall portion 12, the shower head 22 and the rectifying plate 23 of the processing chamber 2 is made of a metal material, the microwaves are reflected and scattered into the microwave radiation space S.

<Temperature Measurement Unit>

The microwave heating apparatus 1 still further includes a plurality of radiation thermometers 26 for measuring a surface temperature of the wafer W; and a temperature measurement unit 27 connected to the radiation thermometers 26. In FIG. 1, only the radiation thermometer for measuring a surface temperature of the central portion of the wafer W is illustrated and the other radiation thermometers 26 are not shown. The radiation thermometers 26 are extended from the bottom portion 13 toward a location where the wafer W will be disposed in such a way that the upper portions of the radiation thermometers 26 approach the bottom surface of the wafer W.

<Microwave Introducing Unit>

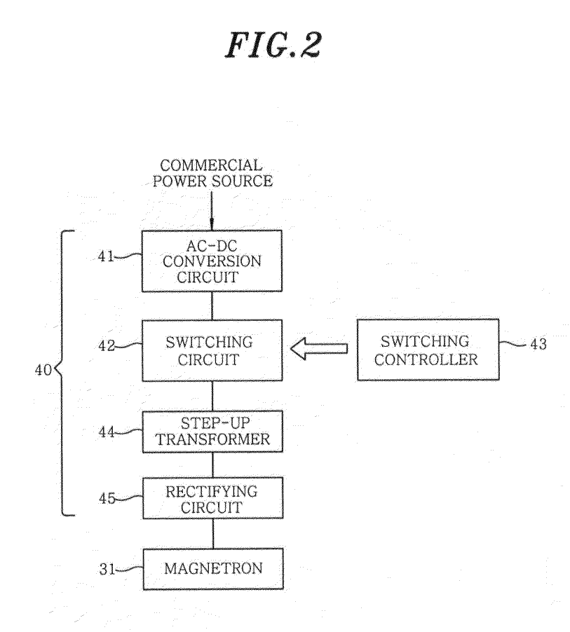

Next, the configuration of the microwave introducing unit 3 will be described with reference to FIGS. 1 and 2. FIG. 2 explains a schematic configuration of a high voltage power supply unit 40 of the microwave introducing unit 3.

As described above, the microwave introducing unit 3 is provided above the processing chamber 2 to introduce electromagnetic waves (microwaves) into the processing chamber 2. As shown in FIG. 1, the microwave introducing unit 3 includes a plurality of microwave units 30 for introducing microwaves into the processing chamber 2; and the high voltage power supply unit 40 connected to the microwave units 30.

(Microwave Unit)

In the present embodiment, the microwave units 30 have the same configuration. Each of the microwave units 30 includes a magnetron 31 for generating microwaves for processing the wafer W; a waveguide 32 through which the microwaves generated by the magnetron 31 are transmitted to the processing chamber 2; and a transmitting window 33 that is fixed to the ceiling portion 11 so as to cover the microwave introduction ports 10. The magnetron 31 corresponds to a microwave source in the present invention.

The magnetron 31 has an anode and a cathode (both not shown) to which a high voltage supplied by the high voltage power supply unit 40 is applied. As for the magnetron 31, a device capable of oscillating microwaves of various frequencies may be used. The frequency of the microwaves generated by the magnetron 31 is adjusted to an optimal level in accordance with process types for a target object. For example, in an annealing process, the microwaves preferably have a high frequency of about 2.45 GHz, 5.8 GHz or the like. Especially, a frequency of about 5.8 GHz is more preferably used.

The waveguide 32 is of a tubular shape having a rectangular cross section and extends upward from the top surface of the ceiling portion 11 of the processing chamber 2. The magnetron 31 is connected to a substantially upper end portion of the waveguide 32. A lower end portion of the waveguide 32 comes into contact with a top surface of the transmitting window 33. The microwaves generated by the magnetron 31 are introduced into the processing chamber 2 through the waveguide 32 and the transmitting window 33.

The transmitting window 33 is made of a dielectric material, e.g., quartz, ceramic or the like. The space between the transmitting window 33 and the ceiling portion 11 is airtightly sealed by a sealing member (not shown). A vertical distance (gap G) from a bottom surface of the transmitting window 33 to a height level corresponding to the surface of the wafer W supported by the supporting pins 14 is preferably set to, e.g., about 25 mm or more and more preferably set in a range from about 25 mm to 50 mm, in order to prevent the microwaves from being directly radiated onto the wafer W.

The microwave unit 30 further includes a circulator 34, a detector 35, and a tuner 36 which are provided on the waveguide 32; and a dummy load 37 connected to the circulator 34. The circulator 34, the detector 35 and the tuner 36 are provided in that order from the upper end portion of the waveguide 32. The circulator 34 and the dummy load 37 serve as an isolator for isolating reflected waves from the processing chamber 2. In other words, the circulator 34 transmits the reflected waves from the processing chamber 2 to the dummy load 37, and the dummy load 37 converts the reflected waves transmitted by the circulator 34 into heat.

The detector 35 serves to detect the reflected waves from the processing chamber 2 in the waveguide 32. The detector 35 includes, e.g., an impedance monitor, specifically a standing wave monitor for detecting an electric field in the waveguide 32. The standing wave monitor may be formed of, e.g., three pins protruding into the inner space of the waveguide 32. The reflected waves from the processing chamber 2 can be detected by detecting a location, a phase and an intensity of an electric field of standing waves by the standing wave monitor. Further, the detector 35 may be formed of a directional coupler capable of detecting traveling waves and reflected waves.

The tuner 36 serves to adjust an impedance between the magnetron 31 and the processing chamber 2. The impedance matching by the tuner 36 is performed based on the detection result of the reflected waves by the detector 35. The tuner 36 may be formed of, e.g., a conductor plate (not shown) capable of projecting into and retracting from the inner space of the waveguide 32. In that case, by adjusting the projecting amount of the conductor plate into the inner space of the waveguide 32, it is possible to control the power amount of the reflected wave to thereby adjust the impedance between the magnetron 31 and the processing chamber 2.

(High Voltage Power Supply Unit)

The high voltage power supply unit 40 supplies a high voltage for generating microwaves to the magnetron 31. As shown in FIG. 2, the high voltage power supply unit 40 includes an AC-DC conversion circuit 41 connected to a commercial power source; a switching circuit 42 connected to the AC-DC conversion circuit 41; a switching controller 43 for controlling an operation of the switching circuit 42; a step-up transformer 44 connected to the switching circuit 42; and a rectifying circuit 45 connected to the step-up transformer 44. The magnetron 31 is connected to the step-up transformer 44 via the rectifying circuit 45.

The AC-DC conversion circuit 41 serves to convert alternating currents (AC) (e.g., three-phase 200V) from the commercial power source into direct currents (DC) of a predetermined waveform by rectification. The switching circuit 42 controls on and off of the DC converted by the AC-DC conversion circuit 41. In the switching circuit 42, phase-shift type PWM (Pulse Width Modulation) control or PAM (Pulse Amplitude Modulation) control is performed by the switching controller 23 to generate a pulse-shaped voltage waveform. The step-up transformer 44 boosts the voltage waveform outputted from the switching circuit to a predetermined level. The rectifying circuit 45 serves to rectify the voltage boosted by the step-up transformer 44 and supply the rectified voltage to the magnetron 31.

<Shape of Sidewall Portion and Arrangement of Microwave Introduction Ports>

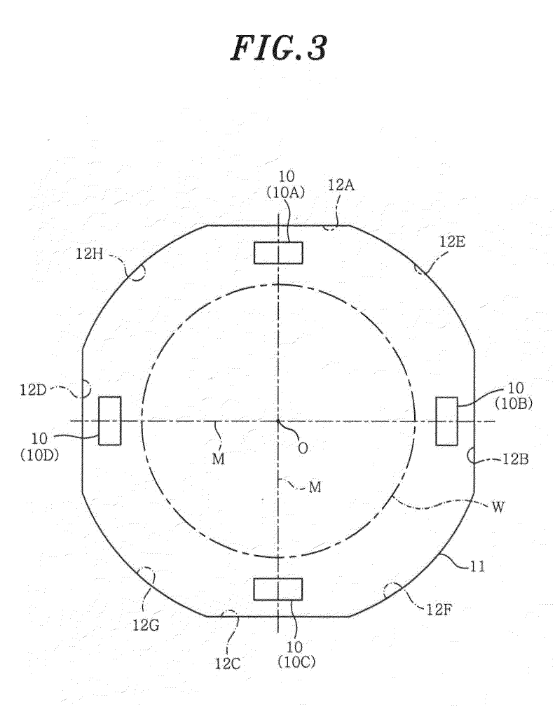

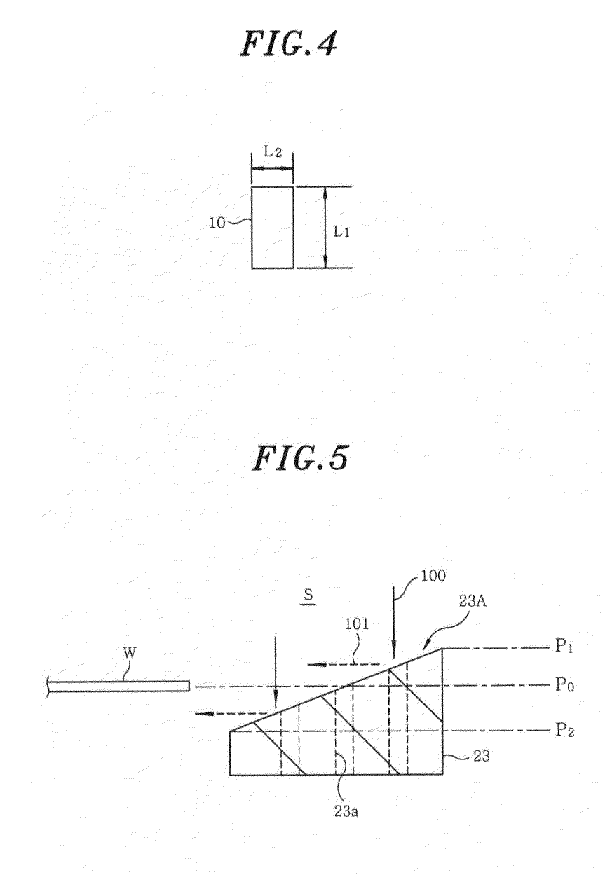

Next, the relationship between the shape of the sidewall portion 12 and the arrangement of the microwave introduction ports 10 in the present embodiment will be described in detail with reference to FIGS. 1, 3 and 4. FIG. 3 shows a state in which the bottom surface of the ceiling portion 11 of the processing chamber 2 shown in FIG. 1 is seen from the inside of the processing chamber 2. FIG. 4 is an enlarged plan view showing one microwave introduction port 10. In FIG. 3, the size and the position of the wafer W are indicated by a double dotted line on the ceiling portion 11. A notation “O” indicates the center of the wafer W. In the present embodiment, the notation O also indicates the center of the ceiling portion 11.

The sidewall portion 12 has four straight sides and four curved sides disposed between the straight sides in a horizontal cross section. The inner wall surfaces of the sidewall portion 12 serve as reflection surfaces for reflecting microwaves. In FIG. 3, for the convenience of explanation, reference numerals 12A to 12H are assigned to the four straight sides and the four curved sides in order to distinguish them in the boundary between the ceiling portion 11 and the inner wall surfaces of the sidewall portion 12.

As shown in FIG. 3, the shape of the boundary between the ceiling portion 11 and the inner wall surfaces of the sidewall portion 12 corresponds to the horizontal cross sectional shape of the sidewall portion 12. In other words, in FIG. 3, the four straight sides 12A to 12D correspond to four straight sides in the horizontal cross section of the sidewall portion 12, and the four curved sides 12E to 12H correspond to four curved sides in the horizontal cross section of the sidewall portion 12.

Therefore, in the following description, the expression “four straight sides 12A to 12D” includes straight sides in the horizontal cross sectional shape of the sidewall portion 12, and the expression “four curved sides 12E to 12H” includes curved sides in the horizontal cross sectional shape of the sidewall portion 12. In the inner wall surfaces of the sidewall portion 12, portions corresponding to the four straight sides are flat surfaces, and portions corresponding to the four curved sides are curved surfaces. A notation “M” in FIG. 3 indicates a central line passing through the center O of the ceiling portion 11 and the central points of the straight sides 12A to 12D. The center of the wafer W and the center of the ceiling portion 11 need not necessarily coincide with each other.

As shown in FIG. 3, in the present embodiment, four microwave introduction ports 10 are equidistantly arranged in the ceiling portion 11. Hereinafter, in order to distinguish the four microwave introduction ports 10, reference numerals 10A to 10D will be assigned thereto. In the present embodiment, microwave units 30 are respectively connected to the microwave introduction ports 10. In other words, the four microwave units 30 are provided.

The microwave introduction ports 10 are of a rectangular shape having long sides and short sides when viewed from the plane. A ratio (L₁/L₂) of a length L₁ of the long sides to a length L₂ of the short sides of the microwave introduction ports 10 is preferably set within a range from, e.g., about 1.2 to 3, and more preferably within a range of about 1.5 to 2.5. Further, the ratio (L₁/L₂) is greater than about 1.

The reason that the ratio (L₁/L₂) is set within the range of about 1.2 to 3 is because the directivity of the microwaves radiated from the microwave introduction ports 10 into the processing chamber 2 needs to be controlled. In other words, when the ratio (L₁/L₂) is smaller than about 1.2, the difference between the directivity of the microwaves toward the direction parallel to the long sides of the microwave introduction ports 10 (direction perpendicular to the short sides) and the directivity of the microwaves toward the direction perpendicular to the long sides of the microwave introduction ports 10 (direction parallel to the short sides) becomes zero. Meanwhile, when the ratio (L₁/L₂) is greater than about 3, the directivity of the microwaves toward the direction parallel to the long sides of the microwave introduction ports 10 or portions directly below the microwave introduction ports 10 is excessively lowered. Therefore, the heating efficiency of the wafer W may deteriorate.

As such, in the present embodiment, by setting the ratio (L₁/L₂) within the range from about 1.2 to 3, it is possible to make the directivity of the microwaves toward the direction perpendicular to the long sides of the microwave introduction ports 10 slightly stronger than the directivity of the microwaves toward the direction parallel to the long sides of the microwave introduction ports 10.

The length L₁ of the long sides of the microwave introduction ports 10 preferably satisfies the equation: L₁=n×λg/2 (n being an integer), wherein λg indicates a wavelength in the waveguide 32. More preferably, n is set to 2. The microwave introduction ports 10 may have different sizes or different ratios (L₁/L₂). However, it is preferable that the four microwave introduction ports 10 have the same size and the same shape in view of improving controllability and uniformity of the heating process for the wafer W.

In the present embodiment, the four microwave introduction ports 10 are arranged to deviate from directly above the wafer W. In other words, the four microwave introduction ports 10 are not vertically overlapped with the wafer W supported by the supporting unit 4.

In the present embodiment, the four microwave introduction ports 10 are provided in such a way that the long sides thereof are parallel to at least one of the four straight sides 12A to 12D. For example, in FIG. 3, the long sides of the microwave introduction ports 10A are parallel to the straight sides 12A and 12C. The directivity of the microwaves radiated from the microwave introduction ports 10a which has a ratio (L₁/L₂) ranging from, e.g., about 1.2 to 3 tends to be higher in a direction perpendicular to the long sides than in a direction parallel to the long sides.

Further, the microwaves transmitted toward the direction perpendicular to the long sides among the microwaves radiated from the microwave introduction ports 10A are reflected by the inner wall surface having the straight sides 12A and 12C. The inner wall surface having the straight sides 12A and 12C is flat and parallel to the long sides of the microwave introduction ports 10A and thus, the reflected waves are dispersed into the processing chamber 2. As such, it is possible to control the directions of the microwaves radiated from the microwave introduction ports 10 and the reflected waves thereof, by arranging the four microwave introduction ports 10 which have the ratio (L₁/L₂) ranging from, e.g., about 1.2 to 3 such that the long sides thereof are in parallel to the respective flat inner wall surface of the four straight sides 12A to 12D of the sidewall portion 12.

In the present embodiment, the four microwave introduction ports 10 having the ratio (L₁/L₂) ranging from, e.g., about 1.2 to 3 are circumferentially arranged at positions spaced apart from each other at an interval of about 90°. In other words, the four microwave introduction ports 10 are rotationally symmetrically disposed about the center O of the ceiling portion 11, and the rotation angle is about 90°.

By symmetrically arranging the four microwave introduction ports 10 about the center O of the ceiling portion 11, the microwaves can be uniformly introduced into the processing chamber 2. Moreover, the center of each of the microwave introduction ports 10 need not coincide with the central line M. Accordingly, for example, the microwave introduction ports 10 may be arranged at locations deviated from the central line M.

However, in view of uniform introduction of the microwaves into the processing chamber 2, the microwave introduction ports 10 are preferably arranged near the central line M. More preferably, the microwave introduction ports 10 are arranged such that some of the microwave introduction ports 10 coincide with the central line M, as shown in FIG. 3. Most preferably, the center of each of the microwave introduction ports 10 coincides with the central line M.

Although the microwave introduction port 10A has been described as an example, the other microwave inlet ports 10B to 10D are also arranged such that the above-described relationship is satisfied between the corresponding microwave introduction ports 10 and the corresponding sidewall portion 12.

<Arrangement of Inclined Portion and Microwave Introduction Ports>

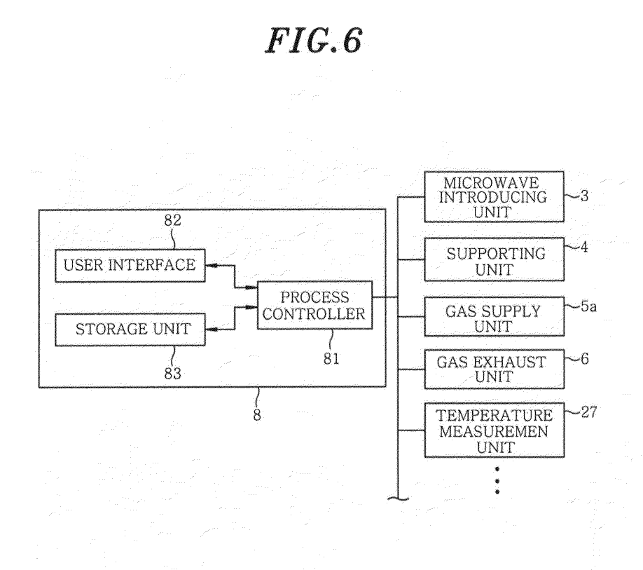

Hereinafter, the relationship between the arrangement of the inclined portion 23A and the arrangement of the microwave introduction ports 10 in the present embodiment will be described in detail with reference to FIGS. 1, 3 and 5. FIG. 5 is an explanatory view showing the effect of the inclined portion 23A. As described above, the shower head 22 and the rectifying plate 23 in the gas supply mechanism 5 serve as partitioning portions for defining the lower side of the microwave radiation space S. Further, the rectifying plate 23 includes the inclined portion 23A for reflecting the microwaves toward the wafer W. In other words, in the vicinity of the wafer W, the top surface of the rectifying plate 23 which surrounds the wafer W is inclined to have an opening widened from the side of the wafer W (inner side) toward the side of the sidewall portion 12 (outer side). The inclined portion 23A is disposed to correspond to the four microwave introduction ports 10 in a vertical direction.

In the present embodiment, in order to efficiently focus the microwaves on the center of the wafer W, the inclined portion 23A of the rectifying plate 23 is provided to have a position P1 higher than a reference position P0 corresponding to the height of the wafer W and a position P2 lower than the reference position P0. Specifically, as shown in FIG. 5, the upper end of the inclined upper surface (the inclined portion 23A) of the rectifying plate 23 is located at a position (the upper position P1) upper than the wafer W supported by the supporting pins 14. Further, the lower end of the inclined upper surface of the rectifying plate 23 (the inclined portion 23A) is located at a position (the lower position P2) lower than the wafer W supported by the supporting pins 14.

In FIG. 5, the direction of the microwaves reflected by the inclined portion 23A of the rectifying plate 23 is schematically shown by electromagnetic vectors 100 and 101. In the present embodiment, the inclined portion 23A is disposed to face the four microwave introduction ports 10 in a vertical direction, so that the microwaves that have been radiated from the microwave introduction ports 10 and transmitted downward to the microwave radiation space S (i.e., from the ceiling portion 11 of the processing chamber 2 toward the rectifying plate 23) can be reflected by the inclined portion 23A and transmitted toward the center of the wafer W. In this way, the microwaves can be focused on the center of the wafer W. As a consequence, it is possible to improve the heating efficiency by using the reflected waves and uniformly heat the entire surface of the wafer W.

The angle and the width of the inclined portion 23A are uniform along the inner wall surfaces of the sidewall portion 12 (along the entire circumference of the wafer W). The angle of the upper surface (the inclined portion 23A) of the rectifying plate 23 may be arbitrarily set as long as the microwaves radiated from the microwave introduction ports 10 can be effectively reflected toward the wafer W. Specifically, it may be properly set in consideration of the arrangement and the shape (e.g., the ratio L₁/L₂), the gap G and the like of the microwave introduction ports 10.

In the microwave heating apparatus 1 of the present embodiment, the number of components can be reduced and the apparatus configuration can be simplified by providing the inclined portion 23A at the rectifying plate 23, compared to the case of providing the inclined portion as a separate member. The inclined portion 23A is preferably provided directly below the microwave introduction ports 10. Although it is not necessary to provide the inclined portion 23A along the entire peripheral portion of the wafer W, the inclined portion 23A is preferably provided along the entire peripheral portion of the wafer W in order to uniformly heat the wafer W by dispersing the microwaves in the processing chamber 2.

<Control Unit>

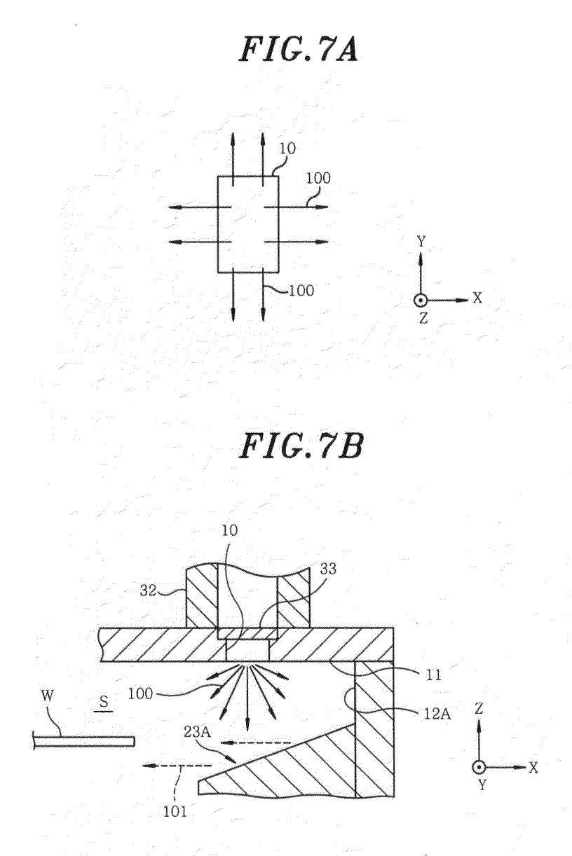

Various components of the microwave heating apparatus 1 are connected to the control unit 8 and controlled by the control unit 8. The control unit 8 is typically a computer. FIG. 6 explains a configuration of the control unit 8 shown in FIG. 1. In the example shown in FIG. 6, the control unit 8 includes a process controller 81 having a CPU; and a user interface 82 and a storage unit 83 which are connected to the process controller 81.

The process controller 81 serves to control the components (e.g., the microwave introducing unit 3, the supporting unit 4, the gas supply unit 5a, the gas exhaust unit 6, the temperature measurement unit 27 and the like) of the microwave heating apparatus 1 which are related to the processing conditions such as a temperature, a pressure, a gas flow rate, a microwave output and the like.

The user interface 82 includes a keyboard or a touch panel on which a process operator inputs commands to operate the microwave heating apparatus 1; a display for visually displaying the operation status of the microwave heating apparatus 1; and the like.

The storage unit 83 stores therein control programs (software) or recipes including processing condition data to be used in realizing various processes that are performed by the microwave heating apparatus 1 under the control of the process controller 51. If necessary, the process controller 81 retrieves a control program or recipe from the storage unit 83 in accordance with an instruction from the user interface 82 and executes the control program or recipe. As a consequence, a desired process in the processing chamber 2 of the microwave heating apparatus 1 is performed under the control of the process controller 81.

The control programs or the recipes may be stored in a computer-readable storage medium, e.g., a CD-ROM, a hard disk, a flexible disk, a flash memory, a DVD, a Blu-ray disc or the like. Further, the recipes may be transmitted on-line from another device through, e.g., a dedicated line, when necessary.

[Processing Sequence]

Hereinafter, a processing sequence for annealing a wafer W in the microwave heating apparatus 1 will be described. First, a command for performing annealing in the microwave heating apparatus 1 is inputted from the user interface 82 to the process controller 81. Second, the process controller 81 receives the command and reads out the recipes that have been stored in the storage unit 83 or the computer-readable storage medium. Then, control signals are transmitted from the process controller 81 to the end devices (e.g., the microwave introducing unit 3, the supporting unit 4, the gas supply unit 5a, the gas exhaust unit 6 and the like) of the microwave heating apparatus 1 such that the annealing process is performed under the conditions based on the recipes.

Thereafter, a gate valve (not shown) is opened, and the wafer W is loaded into the processing chamber 2 through the gate valve and a loading/unloading port (not shown) by a transfer unit (not shown). The wafer W is mounted on the supporting pins 14. Then, the gate valve is closed, and the processing chamber 2 is vacuum-evacuated by the gas exhaust unit 6. At this time, the opening/closing valve 20 is opened, so that the bottom surface of the wafer W is sucked and the wafer W is fixed by suction to the supporting pins 14. Next, a processing gas and a cooling gas of predetermined flow rates are introduced into the processing chamber 2 by the gas supply unit 5a. The inner space of the processing chamber 2 is controlled to a predetermined pressure by adjusting a gas exhaust amount and a gas supply amount.

Thereafter, microwaves are generated by applying a voltage from the high voltage power supply unit 40 to the magnetron 31. The microwaves generated by the magnetron 31 transmit the waveguide 32 and the transmitting window 33, and then are introduced into a space above the wafer W in the processing chamber 2. In the present embodiment, microwaves are sequentially generated by the magnetrons 31 and introduced into the processing chamber 2 through the microwave introduction ports 10. The microwaves may be simultaneously generated by the magnetrons 31 and introduced into the processing chamber 2 through the microwave introduction ports 10.

The microwaves introduced into the processing chamber 2 are reflected by the flat walls of the straight sides 12A to 12D in the sidewall portion 12 or by the inclined portion 23A to be efficiently radiated to the wafer W. Hence, the wafer W is rapidly heated by electromagnetic wave heat such as Joule heat magnetic heat, inductive heat or the like. As a result, the wafer W is annealed.

When a control signal for completing the annealing process is transmitted from the process controller 81 to the end devices of the microwave heating apparatus 1, the generation of the microwaves is stopped and the supply of the processing gas and the cooling gas is stopped. In this manner, the annealing for the wafer W is completed. Next, the gate valve is opened, and the wafer W is unloaded by a transfer unit (not shown).

The microwave heating apparatus 1 is preferably used for an annealing process for activating doping atoms injected into the diffusion layer in the manufacturing process of semiconductor devices, for example.

<Function>

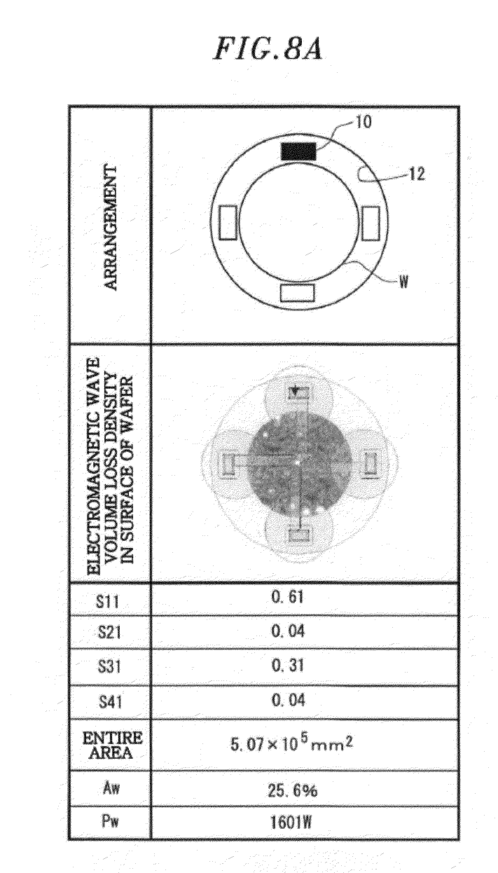

Hereinafter, the functional effects of the microwave heating apparatus 1 and the method for processing a wafer W by using the microwave heating apparatus 1 in accordance with the embodiment of the present invention will be described with reference to FIGS. 3, 7A and 7B. In the present embodiment, with the combination of the shape and arrangement of the microwave introduction ports 10, the shapes of the sidewall portion 12 of the processing chamber 2, and the inclined portion 23A, the microwaves radiated from the microwave introduction ports 10 into the processing chamber 2 are efficiently radiated to the wafer W while the microwaves radiated from one of the microwave introduction ports 10 is suppressed from entering the other microwave introduction ports 10. As a result, the wafer W can be uniformly heated. This principal will be described below.

FIGS. 7A and 7B schematically illustrate radiation directivity of microwaves in the microwave introduction port 10 having the ratio (L₁/L₂) of about 2. FIG. 7A shows the microwave introduction port 10 viewed from below the ceiling portion 11 that is not shown therein. FIG. 7B is a partial enlarged cross sectional view of FIG. 1 to show cross sections of the microwave introduction port 10 and the ceiling portion 11. In FIGS. 7A and 7B, arrows indicate electromagnetic field vectors 100 radiated from the microwave introduction ports 10. Longer arrows indicate stronger directivity of the microwaves. In FIGS. 7A and 7B, the X-axis and the Y-axis are in parallel to the bottom surface of the ceiling portion 11. The X-axis denotes a direction perpendicular to the long side of the microwave introduction ports 10; the Y-axis denotes a direction parallel to the long side of the microwave introduction ports 10; and the Z-axis denotes a direction perpendicular to the bottom surface of the ceiling portion 11.

In the present embodiment, as described above, the four microwave introduction ports 10 formed in a rectangular shape having long sides and short sides when seen from the plane are provided at the ceiling portion 11. Further, the microwave introduction ports 10 used in the present embodiment have the ratio (L₁/L₂) ranging from about 1.2 to 3 and preferably from about 1.5 to 2.5. Therefore, as shown in FIG. 7A, the directivity of the microwave becomes higher in a direction perpendicular to the long sides along the X-axis than in a direction parallel to the long sides along the Y-axis. Accordingly, the microwaves radiated from any of the microwave introduction ports 10 propagate mainly along the ceiling portion 11 of the processing chamber 2 and are reflected by the reflective surfaces corresponding to the inner wall surfaces of the straight sides 12A to 12D of the sidewall portion 12 parallel to the long sides.

In the present embodiment, the long sides of the four microwave introduction ports 10 are in parallel to the flat inner walls of the four straight sides 12A to 12D. Hence, the reflected waves generated from the flat inner walls of the four straight sides 12A to 12D are dispersed into the processing chamber 2, thereby contributing to improvement of power absorption distribution of the wafer W.

In the microwave introduction ports 10 having the ratio (L₁/L₂) that ranges from about 1.2 to 3 and preferably from about 1.5 to 2.5, the radiated microwaves has a downward directivity (i.e., toward the wafer W along the Z-axis) of a constant intensity, as shown in FIG. 7B. In that case, when the wafer W is disposed directly below the microwave introduction ports 10, the ratio of the microwaves which are directly radiated to the wafer W is increased, so that the surface of the wafer W is locally heated.

However, in the present embodiment, the four microwave introduction ports 10 are deviated from directly above the wafer W. Further, the inclined portion 23A is provided around the wafer W so as to face the four microwave introduction ports 10. Therefore, the microwaves that are radiated from the microwave introduction ports 10 and have downward directivity (i.e., toward the wafer W along the Z-axis) are reflected by the inclined portion 23A and transmitted as reflected waves from the periphery of the wafer W toward the center of the wafer W. In addition, reflected waves directed downward among the reflected waves reflected by the flat inner walls of the four straight sides 12A to 12D are further reflected by the inclined portion 23A and transmitted from the periphery of the wafer W toward the center of the wafer W. Accordingly, the reflected waves are focused at the center of the wafer W, and thus the heating efficiency is increased. As a result, the entire surface of the wafer W can be uniformly heated.

In the microwave heating apparatus 1 of the present embodiment, by employing the combination of the shape and arrangement of the microwave introduction ports 10, the shape of the sidewall portion 12 and the arrangement of the inclined portion 23A, the microwaves having the radiation directivity shown in FIGS. 7A and 7B and/or the reflected waves thereof can be focused at the wafer W while the microwaves radiated from one of the microwave introduction ports 10 is suppressed from entering the other microwave introduction ports 10. Accordingly, the use efficiency of supplied power can be improved.

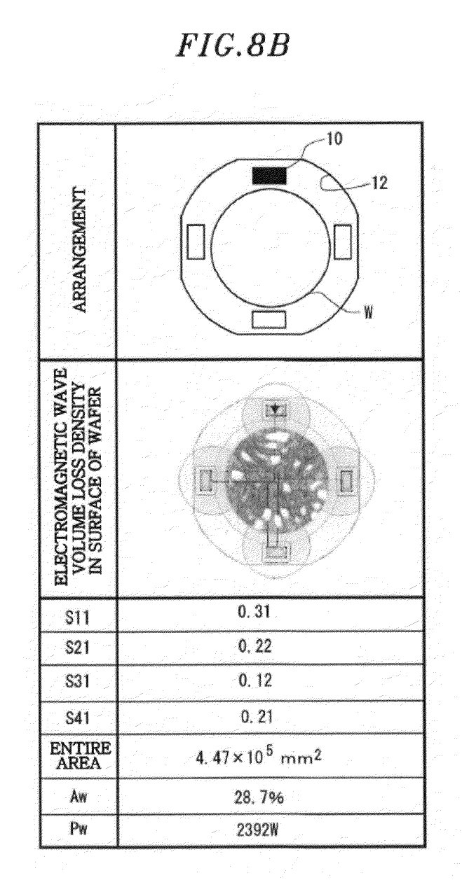

Next, a result of simulation on the power absorption efficiency of the wafer W in the case of varying the shape of the processing chamber and the shape and the arrangement of the microwave introduction ports 10 will be described with reference to FIGS. 8A and 8B. The upper images shown in FIGS. 8A and 8B are explanatory schematic views in which the arrangement of the microwave introduction ports 10 and the shape of the sidewall portion 12 of the microwave heating apparatus 1 are projected with respect to the arrangement of the wafer W. The intermediate images shown in FIGS. 8A and 8B are simulation result maps showing the volume loss density distribution of the microwave power in the surface of the wafer.

The lower images show a scattering parameter, a wafer absorption power (P_{w}), and a ratio (A_{w}) of a wafer area to an entire area (wafer area+inner area of the processing chamber) which can be obtained from the simulation. In this simulation, the examination was performed by introducing the microwaves of about 3000 W from one microwave introduction port indicated by the black box in the upper images of FIGS. 8A and 8B. Moreover, the diameter of the sidewall portion 12 of the processing chamber was set to about 505 mm in FIG. 8A and about 470 mm in FIG. 8B. The gap G was set to about 67 mm in FIG. 8A and about 39.9 mm to 67 mm in FIG. 8B. The height of the wafer W was set to about 13.8 mm in FIGS. 8A and 8B. The dielectric loss tangent (tan δ) of the wafer W was set to about 0.1.

FIG. 8A shows the simulation result of on a configuration of a comparative example in which four microwave introduction ports 10 are provided in a processing chamber having a cylindrical sidewall portion 12 whose horizontal cross section is circular. FIG. 8B shows the simulation result of the microwave heating apparatus 1 of the present embodiment in which the four microwave introduction ports 10 are provided at the processing chamber having the sidewall portion 12 whose horizontal cross section has straight sides and curved sides as shown in FIG. 3.

In FIGS. 8A and 8B, the ratio L₁/L₂ between the long sides L₁ and the short sides L₂ of the microwave introduction ports 10 is set to about 2. Furthermore, in FIGS. 8A and 8B, the microwave introduction ports 10 are arranged above the outside of the outer peripheral portion of the circular wafer W such that a tangential direction of the outer peripheral portion of the wafer W becomes parallel to the longitudinal direction of the microwave introduction ports 10. In the simulation of FIG. 8B, the inclined portion 23A configured as shown in FIG. 1 is provided.

Here, the absorption power of the wafer W may be calculated by using scattering parameters (S parameters). On the assumption that an input power is Pᵢₙ and an entire power absorbed by the wafer W is P_{w}, the entire power P_{w} may be calculated by the following Eq. 1. Notations “S11,” “S21,” “S31” and “S41” denote S parameters of the four microwave introduction ports 10. The microwave introduction port 10 indicated by the black box corresponds to PORT 1.

P_{w}=Pₙ(1−|S11|²−|S21|²−|S31|²−|S41|²) Eq. 1

In order to increase the power absorption efficiency of the wafer W, it is preferable to increase a ratio of an area of the wafer W to the inner area of the processing chamber which defines the microwave radiation space S and also preferable to increase “A_{w}” shown in the following Eq. 2. A_{w} represents a ratio of the wafer area to the entire area (the wafer area+the inner area of the processing chamber).

A_{w}=[wafer area/(wafer area+inner area of processing chamber)]×100 Eq. 2

The distribution of the power absorption in the surface of the wafer W was obtained by calculating an electromagnetic wave volume loss density by using pointing vectors in the surface of the wafer W. Further, the entire power P_{w} absorbed by the wafer W and the power p_{w} absorbed by the wafer W per unit volume may be calculated by the following Eqs. 3 and 4, respectively. The maps in the intermediate images of FIGS. 8A and 8B were created by calculating such values by using an electromagnetic field simulator and plotting same on the wafer W. Although the electromagnetic wave volume loss density is not explicitly expressed because the maps are indicated by black and white, the lighter black (white) indicates the higher electromagnetic wave volume loss density in the surface of the wafer W.

$$\begin{matrix}{P}_{w} [ w ] = \int {\int }_{sw} Re \vec{S} \cdot \vec{n} d S \\ = {\int \int }_{sw} {\int }_{0}^{δ w} Re [ \frac{1}{2} ( \vec{E} \cdot \vec{J} * - ∇ \times \vec{E} \cdot \vec{H} * ) ] d S d Z\end{matrix} \qquad Eq . 3$$

where \vec{S}, \vec{J}, \vec{E} and \vec{H} respectively indicate pointing vector, current density, electric field and magnetic field.

$${p}_{w} [ W / {m}^{3} ] = Re [ \frac{1}{2} ( \vec{E} \cdot \vec{J} * - ∇ \times \vec{E} \cdot \vec{H} * ) ] \qquad Eq . 4$$

In the case of using the wafer W as a target object to be processed, Joule loss mainly occurs in the Eqs. 3 and 4. Therefore, the relationship between the power p_{w} absorbed by the wafer W per unit volume and the electric field may be expressed by using the following Eq. 5 modified from the Eq. 4. The power p_{w} absorbed by the wafer W per unit volume is substantially in proportion to a square of the electric field.

$${p}_{w} [ W / {m}^{3} ] = Re [ \frac{1}{2} ( \vec{E} \cdot \vec{J} * - ∇ \times \vec{E} \cdot \vec{H} * ) ] \approx σ {\vert \vec{E} \vert}^{2} ∝ {\vert \vec{E} \vert}^{2} \qquad Eq . 5$$

The comparison between FIGS. 8A and 8B reveals that the case shown in the FIG. 8B which employs the combination of the shape and arrangement of the microwave introduction ports 10, the shape of the sidewall portion 12 of the processing chamber 2 and the inclined portion 23A in accordance with the present embodiment ensures a small difference in the electric field, an increased entire power P_{w} absorbed by the wafer W and an excellent power absorption efficiency. Moreover, the ratio A_{w} of the area of the wafer W to the inner area of the processing chamber which defines the microwave radiation space S is higher in the case shown in FIG. 8B than the case shown in FIG. 8A.

As can be seen from the above simulation results, the microwave heating apparatus 1 of the present embodiment provides excellent power use efficiency and heating efficiency by reducing the loss of the microwaves radiated into the processing chamber 2. Besides, it was found that the wafer W can be uniformly heated by using the microwave heating apparatus 1 of the present embodiment.

The present invention may be variously modified without being limited to the above embodiment. For example, in the microwave heating apparatus of the above embodiment, the semiconductor wafer is used as a target substrate to be processed. However, the present invention may also be applied to a microwave heating apparatus using, e.g., a substrate for a solar cell panel or a substrate for a flat panel display, as the target substrate.

In the above embodiment, the processing chamber 2 includes the sidewall portion 12 having the four straight sides 12A to 12D and the four curved sides 12E to 12H in the a horizontal cross section are alternately arranged. However, the sidewall portion 12 may have another horizontal cross sectional shape as long as it has four straight sides corresponding to the arrangement of the microwave introduction ports 10. For example, the present invention may also be applied to the case where the sidewall portion has a quadrilateral or an octagonal horizontal cross sectional shape.

Since, in the above embodiment, the bottom of the microwave radiation space S is defined by the shower head 22 and the rectifying plate 23 of the gas supply mechanism 5, the top surface of the rectifying plate 23 serves as the inclined portions 23A. However, in the case of a microwave heating apparatus that does not have the shower head 22 and the rectifying plate 23, an inclined portion may be provided at the bottom portion 13 of the processing chamber 2. In that case, a part of the inner wall of the bottom portion 13 may be inclined at a predetermined angle, or a separate member having an inclined portion may be provided on the bottom portion 13.

While the invention has been shown and described with respect to the embodiments, it will be understood by those skilled in the art that various changes and modifications may be made without departing from the scope of the invention as defined in the following claims.

What is claimed is:

1. A microwave heating apparatus comprising:
a processing chamber configured to accommodate a target object to be processed, the processing chamber having therein a microwave irradiation space;
a supporting unit configured to support the target object in the processing chamber; and
a microwave introducing unit configured to introduce microwaves for heating the target object into the processing chamber,
wherein the processing chamber includes a top wall, a bottom wall and a sidewall which has four straight sides in a horizontal cross section;
the microwave introducing unit has a first to a fourth microwave source;
the top wall has a first to a fourth microwave introduction port through which the microwaves generated by the first to the fourth microwave source are introduced into the processing chamber;
each of the first to the fourth microwave introduction port is of a substantially rectangular shape having long sides and short sides in a plan view, and the microwave introduction ports are disposed in such a way that the long sides thereof are in parallel to at least one of the four straight sides; and
the first to the fourth microwave introduction port are disposed outwardly of the target object in such a way as not to be overlapped in a vertical direction with the target object supported by the supporting unit, and an inclined portion serving to reflect the microwaves toward the target object is provided directly below the microwave introduction ports.

2. The microwave heating apparatus of claim 1, wherein the first to the fourth microwave introduction ports are circumferentially disposed at positions spaced apart from each other at an angle of about 90°, and each of the straight sides is provided to correspond to one of the first to the fourth microwave introduction ports.

3. The microwave heating apparatus of claim 1, wherein the sidewall has the four straight sides and curved sides disposed between the adjacent straight sides in the horizontal cross section.

4. The microwave heating apparatus of claim 1, wherein the inclined portion is provided to surround the target object.

5. The microwave heating apparatus of claim 1, wherein the microwave radiation space is defined by the top wall, the sidewall and a partition provided between the top wall and the bottom wall, and the inclined portion is provided at the partition.

6. The microwave heating apparatus of claim 1, wherein the inclined portion includes an inclined surface having an upper end higher than a reference position corresponding to a height of the target object and a lower end lower than the reference position.

7. A processing method for heating a target object to be processed by using the microwave heating apparatus described in claim 1.
